(19) United States
(12) Patent Application Publication
(10) Pub. No.: US 2016/0092996 A1
(43) Pub. Date: Mar. 31, 2016

(54) ATTESTATION OF SKILLS AND ACHIEVEMENTS IN ACADEMIC COURSES IN A SOCIAL NETWORK

(71) Applicant: LinkedIn Corporation, Mountain View, CA (US)

(72) Inventor: Rahul Bansal, Mountain View, CA (US)

(21) Appl. No.: 14/502,189

(22) Filed: Sep. 30, 2014

(51) Int. Cl. G06Q 50/00; G06Q 50/20; G06Q 30/00

(52) U.S. Cl. CPC G06Q 50/01; G06Q 30/018; G06Q 50/20

(57) ABSTRACT

Systems and methods are presented for providing an attestation of skills and achievements by academic courses in a social network. In some embodiments, a method is presented. The method may include accessing, in a device, a user-enabled feature to accept academic performance measurements in a user profile of a user in a social network. The method may also include accessing a measurement of academic performance provided by an academic institution, accessing a threshold criterion of academic performance, determining if the measurement of academic performance satisfies the threshold criterion of academic performance, and displaying the measurement of academic performance in the user profile if the measurement of academic performance satisfies the threshold criterion.

### TECHNICAL FIELD

The subject matter disclosed herein generally relates to social networking. In some example embodiments, the present disclosures relate to systems and methods for providing an attestation of skills and achievements in academic courses in a social network.

### BRIEF DESCRIPTION OF THE DRAWINGS

Some embodiments are illustrated by way of example and not limitation in the figures of the accompanying drawings.

FIG. 1 is an example network diagram illustrating a network environment suitable for providing attestation of skills and achievements by academic courses in a social network, according to some example embodiments.

FIG. 2 is a block diagram illustrating components of a social network system, according to some example embodiments.

FIG. 3 is an example member profile of a user of a social network who may have taken one or more academic courses and may desire to display achievements and skills related to those courses, according to aspects of the present disclosure.

FIG. 4 is an illustration showing additional information regarding an attestation of skills and achievements related to academic courses taken, according to some example embodiments.

FIG. 5 is an example illustration of additional academic attestations in a user's profile, according to some example embodiments.

FIG. 6 is a flowchart illustrating an example methodology for providing an attestation of skills and achievements in one or more academic courses in a social network, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems are presented for providing attestation of skills and achievements in academic courses in a social network. The advent of social networks and other social media have allowed many users to easily describe themselves and present their best characteristics, achievements, and skills online. In some cases, in an effort to present the best persona possible, individuals may over-present themselves, and in some cases even put forth false information. In particular, presenting an accurate online depiction academically tends to be even more important than ordinary social contexts. However, it is often difficult to police or verify the representations made online. There are few official checks or certifications available to verify an individual's actual accomplishments versus accomplishments listed online. In addition, even if accurate, descriptions of academic performance may be difficult to interpret, in that it may be difficult to know how challenging a class at one school may be compared to a similar class at another school. This issue can be even more problematic with online courses, as academic standards can vary greatly across schools and even courses within the same school. In addition, online courses can have accreditation issues, in that not all online courses may be accredited.

Aspects of the present disclosure are presented for providing attestation of skills and achievements in academic courses in a social network. In some example embodiments, online users in the social network (e.g., members of the social network) may include working professionals and students who have created online profiles in part to display or advertise their academic and professional credentials. In some example embodiments, professors who have taught classes attended by an online user of the social network (or a course administrator associated with the class) can supply a measure of performance of that user taking the professor's class, either to a system of the social network or to the online user profile itself, with the measure of performance being displayable in the online user's profile. In some example embodiments, this measure of performance can be expressed in percentiles indicating a level of performance in comparison to other students taking the same class. In some example embodiments, the system of the social network can provide a different or modified measure of performance for the online user displayable on the online user's profile, with the modified measure of performance being based at least in part on the measure of performance supplied by the professor. For example, the modified measure of performance can include a performance designation certified by the system of the social network. The certified performance designation can be used to normalize the relative standards of different courses and schools, thereby enabling viewers of various online profiles, e.g., potential recruiters, to compare the performance levels of different individuals in the online social network.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

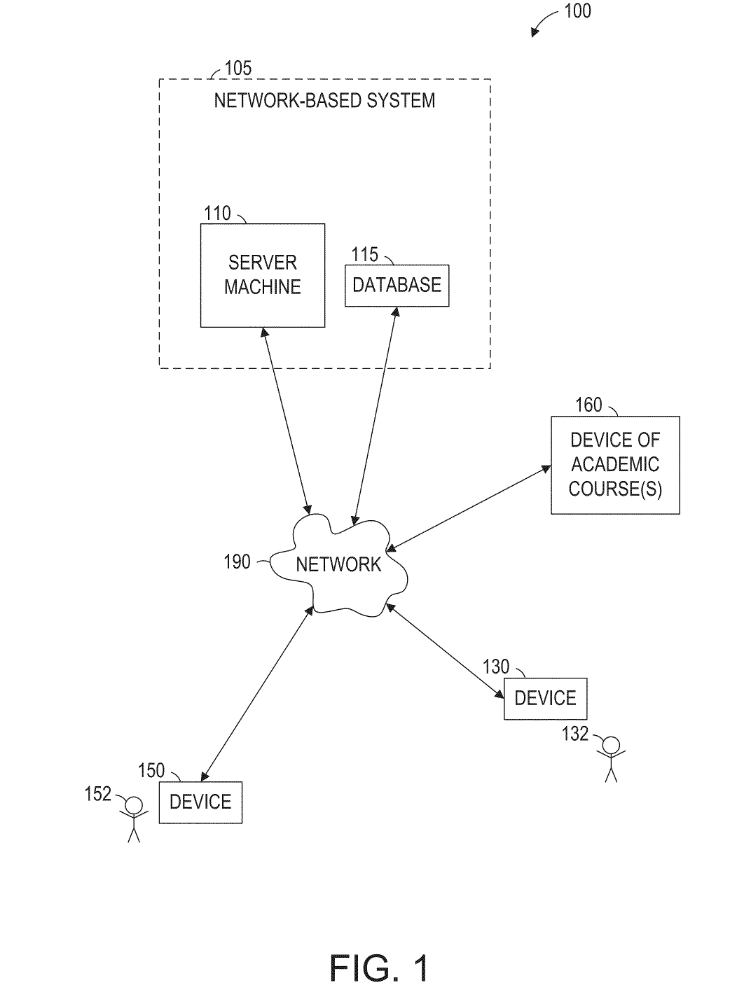

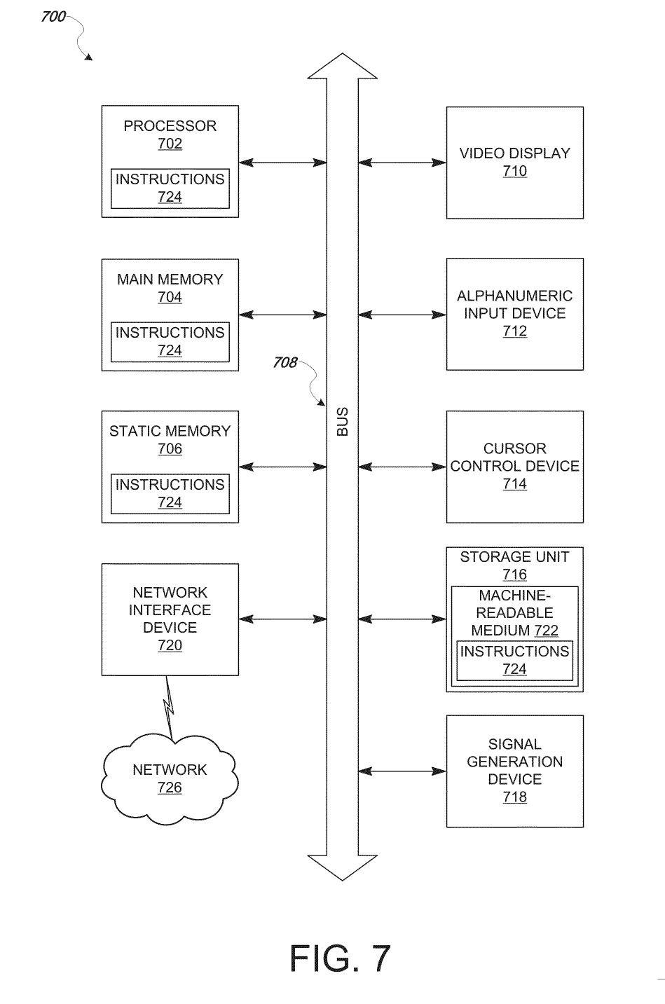

Referring to FIG. 1, an example network diagram illustrating a network environment 100 suitable for providing attestation of skills and achievements in academic courses in a social network is shown, according to some example embodiments. The example network environment 100 includes a server machine 110, a database 115, a first device 130 for a first user 132, and a second device 150 for a second user 152, all communicatively coupled to each other via a network 190. In some cases, a device 160 associated with a university or academic institution offering one or more academic courses is also included and is communicatively coupled to each other via network 190. The server machine 110 may form all or part of a network-based system 105 (e.g., a cloud-based server system configured to provide one or more services to the devices 130 and 152). The database 115 can store search features (e.g., profile data, social graph data) for the social network service. The server machine 110, the first device 130, the second device 150, and the academic course(s) device 160 may each be implemented in a computer system, in whole or in part, as described below with respect to FIG. 7.

Also shown in FIG. 1 are users 132 and 152. One or both of the users 132 and 152 may be a human user (e.g., a human being), a machine user (e.g., a computer configured by a software program to interact with the device 130), or any suitable combination thereof (e.g., a human assisted by a machine or a machine supervised by a human). The user 132 may be associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 may be associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

The academic course(s) device 160 may be configured to provide to the network-based system 105 information associated with one or more academic courses. For example, the device 160 may be configured to provide to the network-based system 105 measures of performance related to a user 132 or 152 taking an academic course associated with the device 160. This information may be stored in the database 115, for example, and may be processed or manipulated in the server machine 110.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 7. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

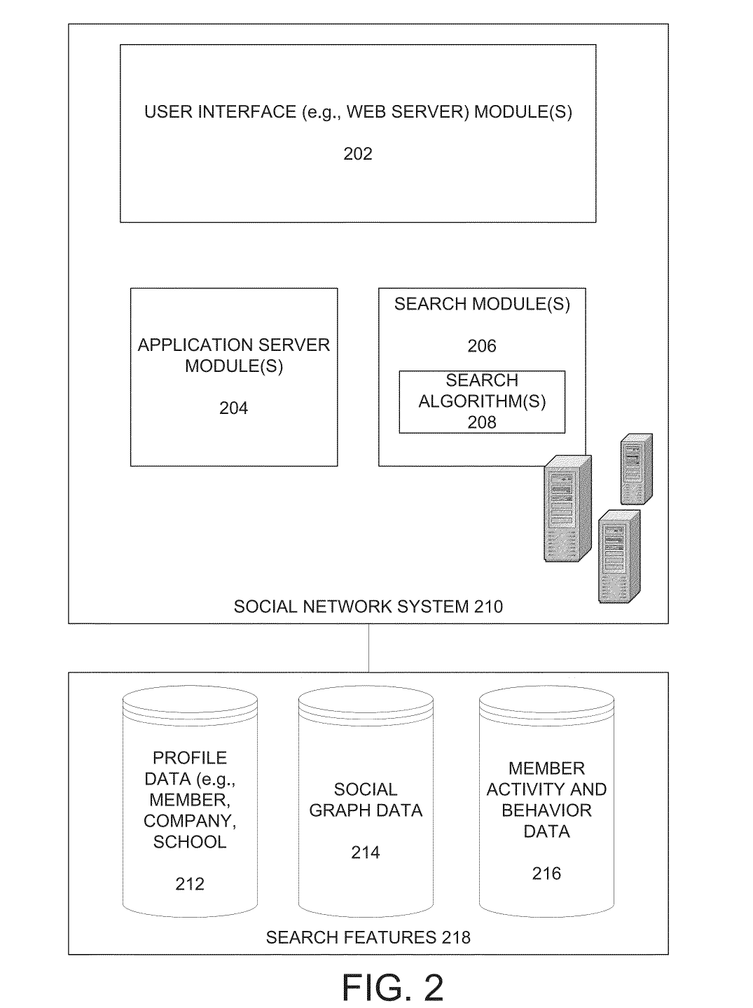

Referring to FIG. 2, a block diagram illustrating components of a social network system 210 is shown, according to some example embodiments. The social network system 210 may be an example of a network-based system 105 of FIG. 1 and may be suitable for providing attestation of skills and achievements by academic courses in the social network system 210. The social network system 210 can include a user interface module 202, application server module(s) 204, and search module(s) 206, which may all be configured to communicate with each other (e.g., via a bus, shared memory, a switch). The search module(s) 206 can further include a database with search algorithms 208. Furthermore, the social network system 210 can communicate with database 115 of FIG. 1, such as a database storing search features 218. The search features 218 can include profile data 212, social graph data 214, and member activity and behavior data 216.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In FIG. 2, in some example embodiments, the front end can include a user interface module (e.g., a web server) 202, which can receive requests (e.g., search requests) via network 190 from various client-computing devices (e.g., devices 130 and 150), and can communicate appropriate responses to the requesting client devices. For example, the user interface module(s) 202 may receive search requests (e.g., name search requests) in the form of Hypertext Transport Protocol (HTTP) requests, or other web-based, application programming interface (API) requests. The application logic layer can include various application server module(s) 204, which, in conjunction with the user interface module(s) 202, can generate various user interfaces (e.g., web pages) with data retrieved (e.g., search results) from various data sources in the data layer. With some embodiments, individual application server modules 204 are used to implement the functionality associated with various services and features of the social network service.

The search module 206, in conjunction with the user interface 202 and the application server module(s) 204, can present search results based on search algorithm(s) 208. The search algorithm(s) 208 can perform functions for finding users with certain listed levels of academic performance provided by various schools to users of the social network system 210, according to some example embodiments. The search algorithm(s) 208 can utilize the various data included in the search features 218, including profile data 212, social graph data 214, and member activity and behavior data 216. Search algorithm(s) 208 can include machine learning techniques. For example, a searcher can request a name search. The search module 206 can use the search algorithm(s) 208 to present names of users in the social network system 210 that may be relevant to the searcher based on search features 218 that are specific to the searcher.

Each of the various modules in social network system 210, e.g., the user interface modules 202, application server modules 204, and search modules 206, can be implemented at least in part by one or more processors in one or more servers of the social network system (e.g., in a server machine 110).

Still referring to FIG. 2, the data layer can include several databases, such as a database for search features 218 for storing profile data 212, including both member profile data as well as profile data for various organizations. Additionally, the database for search features 218 can store social graph data 214 and member activity and behavior data 216.

In some example embodiments, at least some of the profile data 212, social graph data 214, and/or member activity and behavior data 216 can be supplied and modified by academic institutions associated with the social network system 210. For example, the device 160 may be configured to supply information associated with one or more academic courses taken by one or more of the online users in the social network system 210.

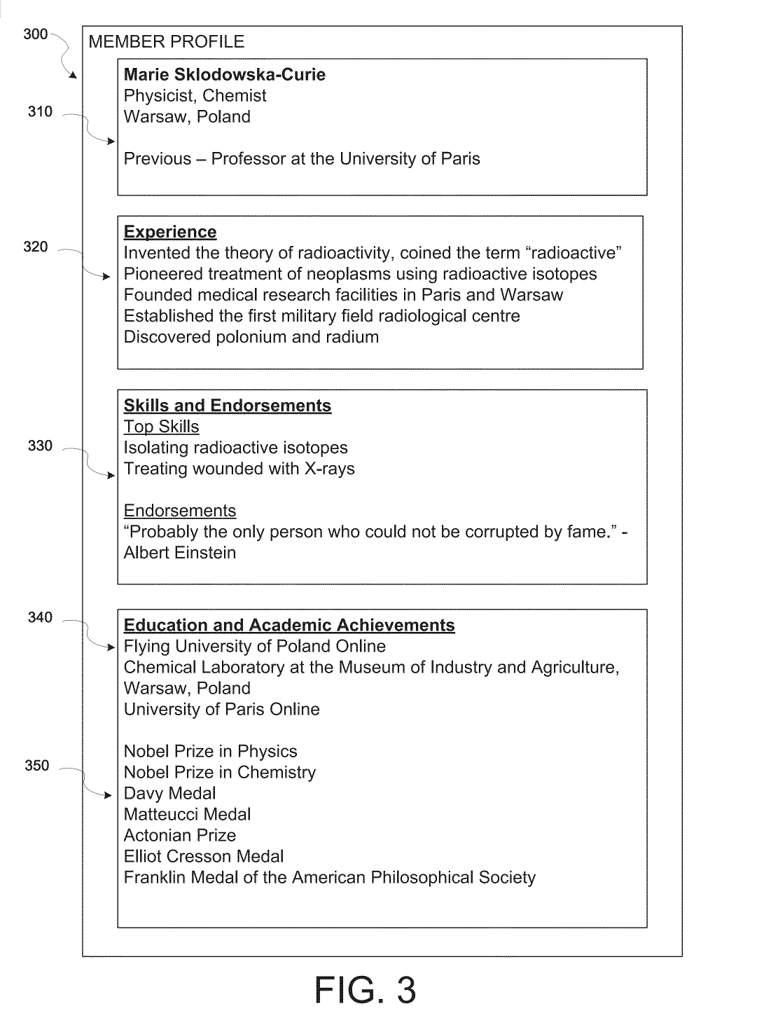

Referring to FIG. 3, example member profile 300 is shown of a user of a social network, e.g., social network system 210, who may have taken one or more academic courses and may desire to display achievements and skills related to those courses, consistent with aspects of the present disclosure. An example of the user can include user 132 or 152. The member profile 300 can include information from the profile data 212, social graph data 214, and/or member activity and behavior data 216. The user, such as user 132, may access the member profile 300 through various user interfaces, such as user interface module 202. The member profile 300 may be stored in memory in a networked server, such as database 115 residing in the network-based system 105.

Various information can be available in the member profile 300 that can attest to the user's 132 various skills and accomplishments. For example, introductory information in window 310 can supply the user's 132 name, geographic location, current occupation, and previous experience. In addition, information in the experience window 320 can provide more detail regarding the user's 132 current and previous work experience, including a more complete history, description, and dates of service.

As another example, window 330 can include a description of skills and endorsements that the user 132 possesses. In this example, a listing of “top skills” is shown, but other information can be included, including a listing of generic skills, any certifications to demonstrate skill or expertise in a particular field, names of other users who have endorsed the user 132 for a particular skill, and a listing of categories for which the user 132 has been endorsed. In some cases, designations like endorsements and the names of people endorsing the user 132 may be provided only through the promotion from other users interacting with the user's 132 profile.

As yet another example, window 340 can include a listing of educational and academic achievements of the user 132. In this example, the user 132 has a listing describing universities attended at physical locations, while also listing one or more universities as being online schools (e.g., universities offering courses online). In some cases, additional information can be provided, such as degrees earned, courses taken, professors from whom the user 132 has taking classes, and the like.

In addition, the user 132 can also list any number of awards or achievements earned academically or otherwise, such as the listing of prizes 350 described in the window including education and academic achievements.

In some example embodiments, the information contained in the member profile 300 can be entered manually by the user, for example, by typing in the information into text fields available in the member profile 300 and associated with each of the windows 310-350. Alternatively, the information in the member profile 300 can be selected from drop-down menus or other preselected text fields, and embodiments are not so limited. In some example embodiments, types of information described in FIG. 3 can be included in the member profile 300 in different ways, such as in different text fields or organized in a different manner apparent to those of ordinary skill in the art, and embodiments are not so limited.

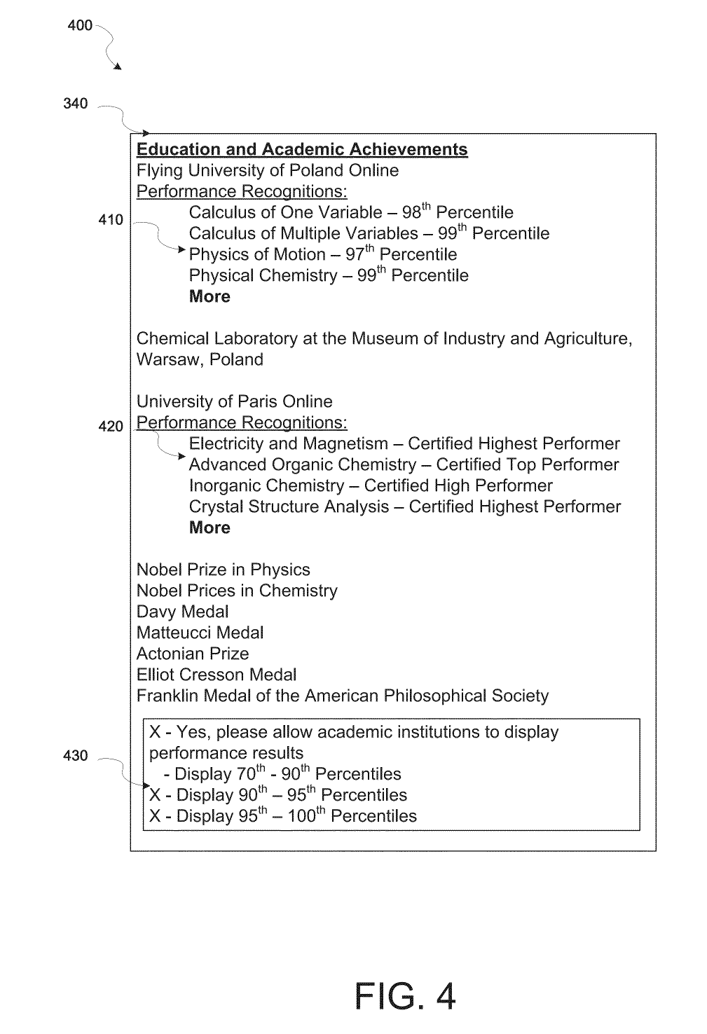

Referring to FIG. 4, illustration 400 shows additional information regarding an attestation of skills and achievements related to academic courses taken, according to some example embodiments. In some example embodiments, the user 132 can enter a description or listing of names or types of classes taken in the window 340, as shown for example in the listings of course descriptions 410 and 420. In other cases, the academic institution providing the courses can fill in the names or titles of the courses taken by the user 132.

Ultimately, the user 132 may desire to display courses in which she has performed well. In some conventional means, certificates listing courses that been completed can be displayed or provided via links on the user's 132 profile. However, a mere listing of a course completion may insufficiently describe the user's ability and performance in the class. For example, a user 132 could achieve a 100% score in a class or a 70% score in the class and still be counted as completing the class. However, demonstrating that the user 132 has earned 100% of the class may reflect better than merely barely completing the class.

Thus, in some embodiments, a more detailed level of performance can be provided in the user's profile. Here for example, the descriptions of the courses in listings 410 and 420 also contain a degree of performance. In listing 410, a description of percentiles for each of the classes is shown. Listing percentiles can be helpful because some classes, even classes with similar descriptions, can be easier at certain universities than others. A listing of percentiles can at least provide an objective level of performance relative to all other users taking the class. In some cases, the percentiles are based on performances of students taking that class in that particular turn. In other cases, the percentiles are based on a more historical listing (for example, an aggregate of students taking the class across multiple terms). In some example embodiments, the percentiles are provided by the academic institutions themselves (for example, from device 160 through network 190 and stored in the database 115 to be displayable in the user's profile 300). Having the measures of performance provided by the academic institutions can increase the level of integrity of the academic representations being made. For example, it may be very easy otherwise for a user to lie or misrepresent her actual performance in a class.

In some example embodiments, a different measure of performance could be displayed in the user's profile 300, based on inputs from the academic institutions and also based on modifications in additional processing provided by the network-based system 105. For example, the listing 420 includes various performance labels for each of the classes described (e.g., “certified highest performer,” “certified top performer,” and “certified high performer”). These performance labels may be labels commonly used across multiple classes, multiple universities, and even multiple users. These performance labels may be used to normalize levels of performance across different schools and universities, where it may be otherwise difficult, for example, to make comparisons by using only a description of percentiles for each class. These performance labels may be generated based on a number of factors in order to normalize the different classes, accounting for degree of difficulty, academic rigor, and the like. For example, ratings of schools and universities, e.g., ratings systems from U.S. News and World Reports, The Princeton Review, or one or more systems generated or adopted by the social network, can place stronger academic weight for classes from certain universities than others. Polls from peers, professors, and even professionals can be gathered to determine relative levels of academic rigor for some schools (or even specific classes or professors) compared to others. Professional earnings data tied with a knowledge of courses taken and universities attended may also provide insight into the relative strength of certain classes, programs, majors, or universities over others. In some example embodiments, a multitude of these factors and/or others apparent to those with skill in the art may be aggregated to form a composite metric score to compare similar classes or programs of the same type across different universities with each other.

In some example embodiments, various settings can be enabled to allow universities to access the user's profile and display varying levels of performance. For example, as shown in settings box 430, the user 132 can enable a setting to allow academic institutions to display performance results in the user's 132 profile 300. In some cases, the user 132 can also specify which classes can be displayed based on how well the user 132 has performed in that class. For example, in illustration 400, the user 132 has checked the boxes for displaying performance results within the 90^{th} through 95^{th} percentiles, and the 95^{th} through 100 percentiles. The user 132 has not checked the box to display any classes where she has earned only 70th through 90^{th} percentiles. In this way, the user 132 has a degree of control over which information is displayed, even though the academic institution may be the entity providing the information.

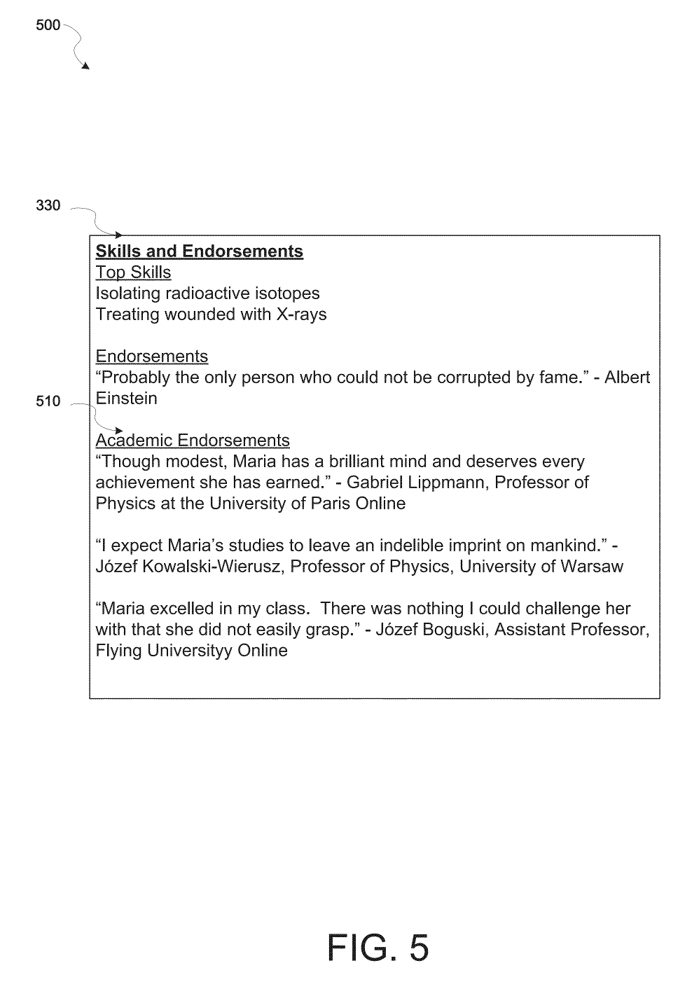

Referring to FIG. 5, an example illustration 500 of additional academic attestations in a user's profile 300 is shown, according to some example embodiments. Along with providing objective scores to rate the user's 132 academic performance, embodiments of the present disclosure can allow for professors and other academic instructors to provide academic subjective endorsements 510, further attesting to the user's 132 academic performance. For example, the window 330 showing skills and endorsements in the user profile 300 can be modified to allow course professors or other academic staff to write personal endorsements of the user 132. In some example embodiments, the professors or other staff writing the endorsements need not be members of the social network, and can provide endorsements through access to the social network arranged between the social network and the academic institution. In some cases, the endorsements can be provided only if the user 132 requests the endorsements from any of her instructors. For example, a user setting in the user profile 300 can enable the user 132 to enter email addresses of various professors to whom requests for recommendations for her may be made. In other cases, the network-based system 105 can provide a list of professors that the user 132 can contact, based on first having verified the user 132 has taken classes with those professors. This verification may be based on the network-based system 105 coordinating course enrollment and other information with multiple academic institutions. In other cases, the professors may volunteer the information (for example. providing endorsements only to the top three students in each class).

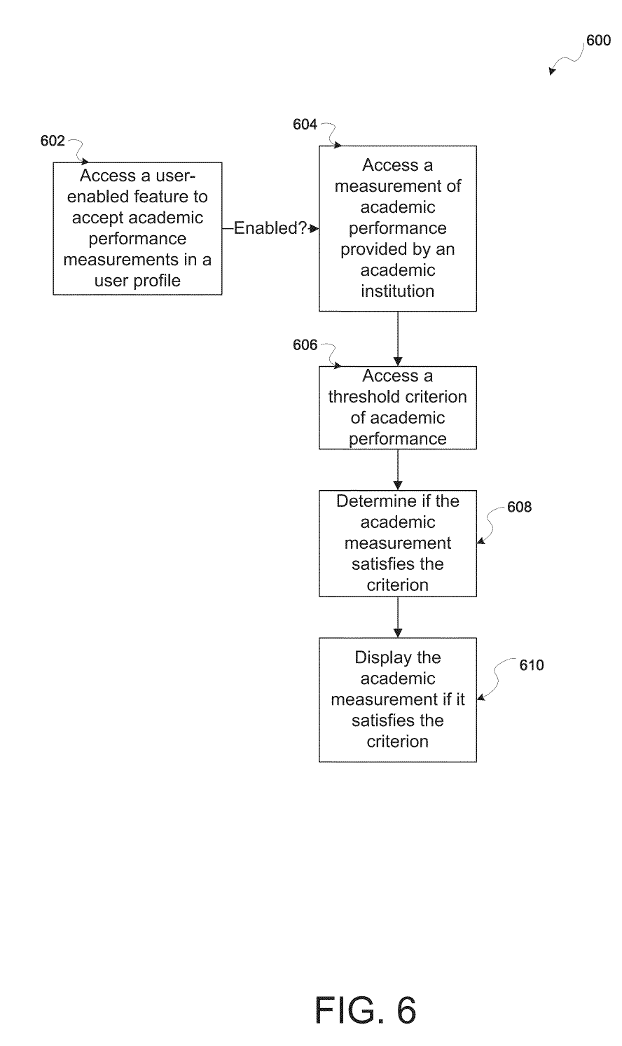

Referring to FIG. 6, the flowchart illustrates an example methodology 600 for providing an attestation of skills and achievements in one or more academic courses in a social network, according to aspects of the present disclosure. The example methodology may be consistent with the methods described herein, including, for example, the descriptions in FIGS. 1-5, and may be directed from the perspective of a network-based system (e.g., network-based system 105) configured to access academic information from academic institutions and manage information contained in a user's profile (e.g. profile 300), with the user being a member of the social network on the network-based system.

At operation 602, the network-based system may access a user-enabled feature to accept academic performance measurements in the user's profile. An example of the user enabled feature can be at least one of the settings in window 432 allowing academic institutions to display performance results, described in FIG. 4. If the setting is enabled, the user may be signaling to the network-based system that information from academic institutions can be included into the user's profile.

An operation 604, assuming the user-enabled feature is, in fact, enabled, the network-based system may access a measurement of academic performance provided by an academic institution. An example of a measurement of academic performance can include a grade or score of the user's overall performance in a course taken at the academic institution. Other examples can include a percentile measurement indicating how the user performed in the class relative to other students. An example of an academic institution can include any university or other academic body providing academic courses in which the user has participated. In some example embodiments, the academic institutions may include online institutions, but embodiments are not so limited. While this methodology 600 discusses a single measurement of academic performance, the methodology can certainly be used for multiple course descriptions and multiple grades or other academic measurements, and embodiments are not so limited.

At operation 606, the network-based system may access a threshold criterion of academic performance. Example of the threshold criterion of academic performance can include a particular percentile threshold, such as the 90^{th} percentile. The user may have selected a feature in her user profile signaling to include classes only where her performance was above the academic performance threshold. In some example embodiments, multiple academic thresholds can be accessed, and embodiments are not so limited.

At operation 608, the network-based system may determine if the academic measurement discussed in operation 604 satisfies the academic performance threshold discussed in operation 606. For example, the grade or other measurement of performance supplied by the academic execution in operation 604 may exceed the users specified academic performance threshold of the 90^{th} percentile. This may qualify as satisfying the academic performance threshold. However, any grades lower than the 90^{th} percentile would not satisfy the threshold.

In operation 610, the network-based system may display the academic measurement supplied by the institution in operation 604 if the academic measurement satisfies the threshold criterion. In some example embodiments, an example of displaying the academic measurement can include displaying a percentile score in the user's profile. In some example embodiments, other icons or graphics can be displayed, indicating the academic measurement is certified by the academic institution itself.

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 1-6. The instructions 724 may also reside, completely or at least partially, within the main memory 704, within the processor 702 (e.g., within the processor's cache memory), or both, before or during execution thereof by the machine 700. The instructions 724 may also reside in the static memory 706.

Accordingly, the main memory 704 and the processor 702 may be considered machine-readable media (e.g., tangible and non-transitory machine-readable media). The instructions 724 may be transmitted or received over a network 726 via the network interface device 720. For example, the network interface device 720 may communicate the instructions 724 using any one or more transfer protocols (e.g., HTTP). The machine 700 may also represent example means for performing any of the functions described herein, including the processes described in FIGS. 1-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, in a device comprising one or more processors, a user-enabled feature to accept academic performance measurements in a user profile of a user in an online social network system;
accessing, in the device, a measurement of academic performance provided by an academic institution;
accessing a threshold criterion of academic performance;
determining that the measurement of academic performance satisfies the threshold criterion of academic performance; and
responsive to determining that the measurement of academic performance satisfies the threshold criterion, displaying the measurement of academic performance in the user profile.

2. The method of claim 1, wherein the measurement of academic performance includes a measurement of performance in an academic course comparing performance between a plurality of students enrolled in the academic course.

3. The method of claim 2, wherein the measurement of performance comparing the performance between the plurality of students includes a percentile measurement indicating the user's ranking in the academic course relative to the plurality of students.

4. The method of claim 1, further comprising generating a normative measurement of academic performance based on the measurement of academic performance provided by the academic institution and a plurality of different measurements of academic performance provided by a plurality of different academic institutions, the normative measurement of academic performance providing a comparison of the user's academic performance to a plurality of performances of a plurality of students enrolled in a plurality of other courses taken at the plurality of different academic institutions.

5. The method of claim 4, further comprising displaying the normative measurement of academic performance in the user's profile.

6. The method of claim 1, further comprising accessing an endorsement from an academic instructor associated with the measurement of academic performance.

7. The method of claim 6, further comprising displaying the endorsement from the academic instructor in the user's profile.

8. A system comprising:
a memory comprising:
a user profile of a user in a social network;
a user-enabled feature to accept academic performance measurements in the user profile;
a measurement of academic performance provided by an academic institution; and
a threshold criterion of academic performance associated with the user profile;
at least one processor coupled to the memory and configured to:
access the user-enabled feature;
access the measurement of academic performance if the user-enabled feature is enabled;
access the threshold criterion of academic performance;
determine that the academic measurement satisfies the threshold criterion; and
display the academic measurement in the user profile responsive to determining that the academic measurement satisfies the threshold criterion.

9. The system of claim 8, wherein the measurement of academic performance includes a measurement of performance in an academic course comparing performance between a plurality of students enrolled in the academic course.

10. The system of claim 9, wherein the measurement of performance comparing performance between the plurality of students includes a percentile measurement indicating the user's ranking in the academic course relative to the plurality of students.

11. The system of claim 8, wherein the at least one processor is further configured to generate a normative measurement of academic performance based on the measurement of academic performance provided by the academic institution and a plurality of different measurements of academic performance provided by a plurality of different academic institutions, the normative measurement of academic performance providing a comparison of the user's academic performance to a plurality of performances of a plurality of students enrolled in a plurality of other courses taken at the plurality of different academic institutions.

12. The system of claim 11, wherein the at least one processor is further configured to display the normative measurement of academic performance in the user's profile.

13. The system of claim 8, wherein the at least one processor is further configured to access an endorsement from an academic instructor associated with the measurement of academic performance.

14. The system of claim 13, wherein the at least one processor is further configured to display the endorsement from the academic instructor in the user's profile.

15. A computer-readable medium embodying instructions that, when executed by a processor perform operations comprising:
accessing, in a device, a user-enabled feature to accept academic performance measurements in a user profile of a user in a social network;
accessing, in the device, a measurement of academic performance provided by an academic institution;
accessing a threshold criterion of academic performance;
determining that the measurement of academic performance satisfies the threshold criterion of academic performance; and
displaying the measurement of academic performance in the user profile responsive to determining that the measurement of academic performance satisfies the threshold criterion.

16. The computer-readable medium of claim 15, wherein the measurement of academic performance includes a measurement of performance in an academic course comparing performance between a plurality of students enrolled in the academic course.

17. The computer-readable medium of claim 16, wherein the measurement of performance comparing performance between the plurality of students includes a percentile measurement indicating the user's ranking in the academic course relative to the plurality of students.

18. The computer-readable medium of claim 15, the operations further comprising generating a normative measurement of academic performance based on the measurement of academic performance provided by the academic institution and a plurality of different measurements of academic performance provided by a plurality of different academic institutions, the normative measurement of academic performance providing a comparison of the user's academic performance to a plurality of performances of a plurality of students enrolled in a plurality of other courses taken at the plurality of different academic institutions.

19. The computer-readable medium of claim 18, the operations further comprising displaying the normative measurement of academic performance in the user's profile.

20. The computer-readable medium of claim 15, the operations further comprising accessing an endorsement from an academic instructor associated with the measurement of academic performance; and displaying the endorsement from the academic instructor in the user's profile.
